(19) United States
(12) Patent Application Publication
(10) Pub. No.: US 2007/0191072 A1
(43) Pub. Date: Aug. 16, 2007

(54) Wireless communication device with circuit for unconnecting data input and method thereof

(76) Inventor: Jun-Hwan Kim, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/245,464

(22) Filed: Oct. 6, 2005

(30) Foreign Application Priority Data
Oct. 6, 2004 (KR) 10-2004-0079448

(51) Int. Cl. H04M 1/00

(52) U.S. Cl. 455/572; 455/127.1

(57) ABSTRACT

A mobile terminal for unconnecting data input to its processor or other circuits based on power input and a method thereof is disclosed. In one embodiment, the mobile terminal includes a processor; a transceiver configured to receive data from an external device and to transmit the data to the processor; and a switch configured to switch the transmission of the data from the transceiver to the processor according to a level of power supplied from the external device. In one embodiment, the method includes determining whether power supplied from an external device is on or off; activating data transmission from the external device to the mobile terminal when the power supplied from the external device is on; and deactivating data transmission from the external device to the mobile terminal when the power supplied from the external device is off.

### BACKGROUND OF THE INVENTION

1.Field of the Invention

The present invention relates to a wireless communication device or mobile terminal. More particularly, the invention relates to a mobile terminal for preventing a power-on error during testing of the mobile terminal, and a method of preventing the same.

2.Description of the Related Technology

A mobile terminal, such as a mobile or cellular phone, a personal digital assistant (PDA), or a handheld PC, has widely been used for communications between mobile terminals or connection to a network such as the Internet. In developing or testing a software program for operating a mobile terminal, the program is first programmed in an external device such as a general purpose computer. Then, the mobile terminal is connected to the external device via wired connection. Next, the program is transferred from the external device to the mobile terminal to test the program. The program is transferred back from the mobile terminal to the external device for modifying or debugging the program.

Because there is a difference in the reference voltage between the external device and the mobile terminal, a connector is provided to compensate the difference. The connector provides a universal asynchronous receiver/transmitter (UART) communication between the external device and the mobile terminal.

FIG. 1 illustrates a block diagram of a prior art mobile terminal. The mobile terminal comprises a recommended standard (RS)-232 transceiver 110, an input/output connector 120, an electromagnetic interference (EMI) filter 130, and a processor 140.

The RS-232 transceiver 110 receives data from an external device such as a personal computer (PC), and inverts the data. Then, it transfers the inverted data to the input/output connector 120. The RS-232 transceiver 110 also transfers data from the input/output connector 120 to the PC. The RS-232 transceiver 210 also receives power from the external device and transfers the power to the input/output connector 120.

The input/output connector 120 transfers the power from the RS-232 transceiver 110 to the main processing unit 140. The input/output connector 120 also transmits the inverted data from the RS-232 transceiver 110 to the EMI filter 130. In addition, the input/output connector 120 receives data from the EMI filter 130, and transfers the data to the RS-232 transceiver 110.

The EMI filter 130 eliminates electromagnetic interference of the data transmitted from the input/output connector 120, and outputs the filtered data to the main processing unit 140. The EMI filter 130 also eliminates electromagnetic interference of the data inputted from the main processing unit 140, and outputs the filtered data to the input/output connector 120.

The main processing unit 140 is driven by the power supplied from the external device through the input/output connector 120. The main processing unit 140 processes the data from the EMI filter 130, and generates data. The generated data is transmitted to the EMI filter 130.

The mobile terminal uses voltage levels different from those used by the external device such as a PC. In order to allow the processor of the mobile terminal to use the data from the external device, the RS-232 transceiver 110 controls voltage levels of the data transmitted from the external device. The RS-232 transceiver also eliminates a ripple component. A ripple component is an AC voltage component from a DC power supply arising from sources within the power supply.

The RS-232 transceiver 110 inverts a signal received from the external device. When the mobile terminal and the external device are not in communication with each other, the received signal remains at a first logic level (Low). When the received signal passes through the RS-232 transceiver 110, it is inverted by the RS-232 transceiver 110. The inverted received signal is at a second logic level (High). The inverted signal at the second logic level (High) is then transmitted to the main processing unit 140.

An activation signal for the main processing unit 140 also has the second logic level (High). The main processing unit 140 thus may take the inverted signal (High) for an activation signal (High) even though the inverted signal is not an actual data signal from the external device. Therefore, when the inverted signal is inputted to the main processing unit 140, the conventional mobile terminal may malfunction, resulting in a power-on error, i.e., faulty turn-on/off or faulty activation of the mobile terminal.

### SUMMARY OF CERTAIN INVENTIVE ASPECTS

One aspect of the invention provides a wireless communication device. The device comprises a power input configured to receive electrical power from an external device; a data input configured to receive a data signal from the external device; a processor configured to process the data signal; and a circuit interconnecting the data input and the processor. The circuit is configured to electrically connect the data input to the processor only when electrical power at the power input is greater than a predetermined level.

The above-described device may comprise a mobile phone, a personal digital assistant (PDA), or a hand-held computer. The circuit may comprise a first terminal connected to the data input, a second terminal connected to the processor, and a switch configured to connect or disconnect the first and second terminals based on the level of the electrical power at the power input. The switch may comprise a transistor comprising a source connected to the first terminal, a drain connected to the second terminal and a gate connected to the power input. The circuit may be configured to electrically disconnect the processor from the data input when the electrical power at the power input is less than the predetermined level. The predetermined level may be a level of electrical power sufficient to operate the processor. The predetermined level may be represented by an electrical potential.

Another aspect of the invention provides a wireless communication device comprising a power input configured to receive electrical power from an external device; a data input configured to receive a data signal from the external device; a processor configured to process the data signal; and a circuit interconnecting the data input and the processor. The circuit is configured to electrically disconnect the data input from the processor when electrical power at the power input is less than a predetermined level.

The above-described device may comprise a mobile phone, a personal digital assistant (PDA), or a hand-held computer. In the device described above, the circuit may comprise a first terminal connected to the data input, a second terminal connected to the processor, and a switch configured to connect or disconnect the first and second terminals based on the level of the electrical power at the power input. The switch may comprise a transistor comprising a source connected to the first terminal, a drain connected to the second terminal and a gate connected to the power input. The circuit may be configured to electrically connect the data input and the processor when the electrical power at the power input is greater than or equal to the predetermined level. The predetermined level may be a level of electrical power sufficient to operate the processor.

Yet another aspect of the invention provides a method of supplying data to a processor of a wireless communication device. The method comprises providing a wireless communication device comprising a processor, a power input, and a data input; providing an external device comprising a power supply port and a data supply port; electrically connecting the power input to the power supply port and the data input to the data supply port; and electrically connecting the data input to the processor only when electric power at the power input is greater than or equal to a predetermined level.

In the above-described method, the data input and the processor may not be electrically connected when the electric power at the power input is less than the predetermined level. The external device may comprise software for testing operation of the wireless communication device. The external device may be configured to supply electrical power to the wireless communication device through the power supply port. In addition, the external device may be configured to supply data for testing the wireless communication device through the data supply port. The external device may have a first level of electric power for operating the external device, wherein the first level is different from the predetermined level. The external device may comprise a circuit for converting the first level to the predetermined level.

In the method described above, the data supply port may occasionally supply an unintended signal to the data input while the power supply does not supply electrical power to the power input at a level lower than the predetermined level. The method may be carried out in the course of testing the wireless communication device. Electrically connecting the data input to the processor may be carried out by a circuit interconnecting the data input and the processor, wherein the circuit may comprise a first terminal connected to the data input, a second terminal connected to the processor, and a switch configured to connect or disconnect the first and second terminals based on the level of the electrical power at the power input. The predetermined level may be a minimum level of electrical power sufficient to operate the processor. The predetermined level may be represented by an electrical potential.

Yet another aspect of the invention provides a mobile terminal having a power-on error prevention function interrupting the received data when the mobile terminal does not communicate with a personal computer (PC) in order to prevent faultily turning-on/off a main processing unit or faultily activating a liquid crystal display (LCD) caused when reversed received data is inputted to the main processing unit of the mobile terminal, and a method thereof.

Another aspect of the invention provides a mobile terminal having a power-on error preventing function, including a transceiver for processing data inputted from an external device and outputting the processed data, and receiving power supplied from the external device and outputting the received power as an operating power; a switch for switching a data path for transferring data inputted from the transceiver according to a level of the operating power supplied from the transceiver; and a main processing unit for processing the data inputted from the switch.

Yet another aspect of the invention provides a method of preventing a power-on error in a mobile terminal, the method including connecting the mobile terminal and an external device; determining whether an operating power of the mobile terminal is activated or inactivated; activating a data path for transferring data from the external device and the mobile terminal when the operating power of the mobile terminal is activated; and interrupting the data path for transferring data from the external device and the mobile terminal when the operating power of the mobile terminal is inactivated.

### BRIEF DESCRIPTION OF THE DRAWINGS

FIG. 1 is a block diagram illustrating a prior art mobile terminal.

FIG. 2 is a block diagram illustrating a mobile terminal having a function preventing a power-on error in accordance with an embodiment.

FIG. 3 is a circuit diagram showing a switch 240 shown in FIG. 2.

FIG. 4 is a flowchart showing a method of preventing a power-on error in a mobile terminal in accordance with an embodiment.

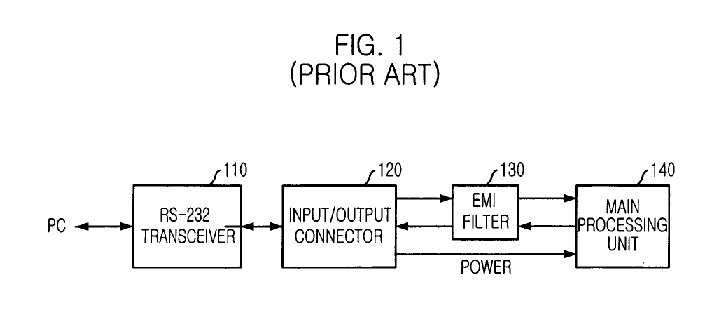

### DETAILED DESCRIPTION OF EMBODIMENTS

Various aspects and features of the invention will become more fully apparent from the following description and appended claims taken in conjunction with the foregoing drawings.

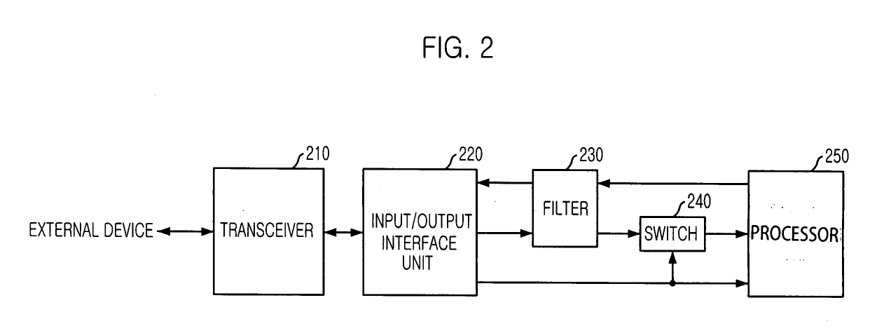

FIG. 2 is a block diagram illustrating a mobile terminal for preventing a power-on error in accordance with an embodiment. Referring to FIG. 2, the mobile terminal for preventing a power-on error includes a transceiver 210, an input/output interface unit 220, a filter 230, a switch 240 and a main processing unit or processor 250.

The transceiver 210 receives data from an external device, for example, a personal computer (PC). It inverts the data received from a personal computer (PC), and outputs the inverted data to the input/output interface unit 220. The transceiver 210 also transfers data from the processor 250 to the PC. The transceiver 210 may comprises a recommended standard (RS)—232 transceiver.

The input/output interface unit 220 receives power from the external device via the transceiver 210. It also transfers the power as an operating power to the processor 250. The input/output interface unit 220 also transfers the inverted data from the transceiver 210 to the filter 230. It also transfers the data from the filter 230 to the transceiver 210 in a reverse direction.

By way of an example, the input/output interface unit 220 comprises 24 pins as shown Table 1 below.

TABLE 1

| | |
|---|---|
| CTS | (1) |
| RFR | (2) |
| TXD | (3) |
| RXD | (4) |
| GND | (5) |
| GND | (6) |
| DTR | (7) |
| DCD | (8) |
| RI | (9) |
| HF_DETECT | (10) |
| MS_RXD | (11) |
| MS_TXD | (12) |
| DATA_PWR | (13) |
| HF_RXA | (14) |
| HF_TXA | (15) |
| DSR | (16) |
| EXT_POWER | (17) |
| EXT_POWER | (18) |
| TDO | (19) |
| TDI | (20) |
| TMS | (21) |
| TCK | (22) |
| TRST/ | (23) |
| TMODE | (24) |

Referring to Table 1, the 11^{th} pin (MS_RXD) transfers data from the external device to the processor 250. The 11^{th} pin may transfer data to a Mobile Station Modem (MSM) of the mobile terminal, for example. The 12^{th} pin (MS_TXD) transfers data inputted from the processor 250 to the PC. The 17^{th} pin and 18^{th} pin (EXT—POWER) transfer the operating power supplied from an external power source to the processor 250.

The filter 230 eliminates electromagnetic interference (EMI) component of the data transmitted from the input/output interface unit 220. It outputs filtered data to the switch 240. The filter 230 also eliminates electromagnetic interference component of data transmitted from the processor 250, and outputs the filtered data to the input/output interface unit 220.

The switch 240 switches a data path for transferring data from the filter 230 to the processor 250 according to a level of the operating power transmitted from the input/output interface unit 220. The switch 240 activates the data path for transferring the data from the filter 230 to the processor 250 when the operating power is on. On the other hand, the switch 240 interrupts the data path for blocking a data flow from the filter 230 to the processor 250.

The processor 250 may be driven by the operating power supplied through the input/output interface unit 220 from the external device. The processor 250 processes the data transmitted via the switch 240, and generates data. The generated data is transmitted to the filter 230.

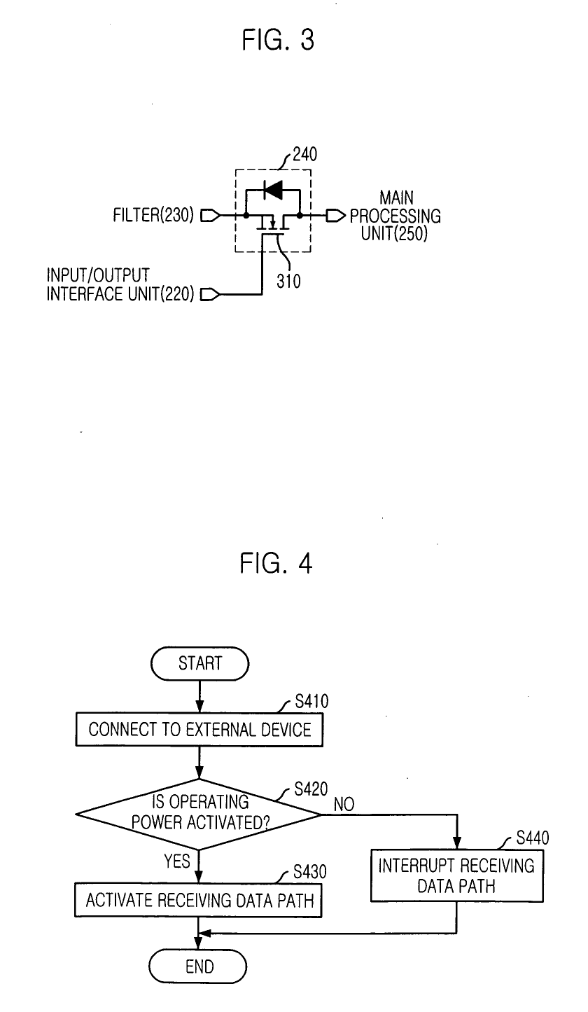

FIG. 3 is a circuit diagram showing a switch 240 shown in FIG. 2. The switch 240 comprises a transistor 310 having a source connected to the filter 230; a gate for receiving an operating power supplied via the input/output interface unit 220 from the external device; and a drain connected to the processor 250. The switch 240 activates the data path for transferring the data from the filter 230 to the processor 250 when the operating power is on. It interrupts the data path for blocking data from the filter 230 to the processor 250 when the operating power is off. The transistor 310 may comprise a MOSFET, bipolar transistor, or other various types of transistors.

The switch may further comprise a one directional device, for example, a diode. The diode is connected in parallel with the switch in a reverse direction. The input of the diode is connected to the output of the switch and the output of the switch is connected to the input of the switch. This arrangement allows data from the processor 250 to the input/output interface unit 220 to bypass the switch 240.

Now referring to FIGS. 3 and 4, the operations of the mobile terminal according to an embodiment will be explained. When the mobile terminal is connected to an external device such as a PC through the input/output interface unit 220, the operating power is supplied from the external device through the 17^{th} and 18^{th} pins (EXT_POWER) to the mobile terminal. In addition, data is transmitted from the external device through the 11^{th} pin (ES_RXD) to the mobile terminal.

If the operating power from the external device is off, the switch 240, an N channel transistor, is maintained in a turn-off state. In other words, when the operating power is below 2.5V, the switch 240 is maintained in a turn-off state. The inverted data is not transmitted from the transceiver to the processor 250 although the data has been inputted to the transceiver from the external device.

On the other hand, when the operating power from the external device is on, the switch 240 is turned on. In other words, when the operating power is increased over 2.5V, e.g, 5V, the switch 240 is turned on. The filtered data is then transferred from the input/output interface unit to the processor 250.

FIG. 4 is a flowchart illustrating a method of preventing a power-on error in a mobile terminal in accordance with an embodiment. Referring to FIGS. 2, 3, and 4, in step S410, the mobile terminal is connected to the external device such as a personal computer (PC). The external device can be connected to the processor through the input/output interface unit 220.

Subsequently, in step S420, it is determined whether the operating power is supplied from the external device. The switch 240 receives the operating power at its switching input, and determines whether the operating power is supplied from the external device via the transceiver 210. In step S430, if the operating power is supplied, the switch 240 activates a data path so as to transmit the received data from the external device to the processor 250. The switch 240 determines whether the operating power exceeds 2.5V, e.g. 5V. If the operating power exceeds 2.5V, the switch 240 allows data signals to flow from the external device to the processor.

On the other hand, in step S440, if the operating power is not supplied from the external device, the switch 240 interrupts the data path to block the data transmission from the external device to the processor 250. For example, if the operating power is below 2.5V, the switch 240 blocks the data flow from the external device to the processor.

The method described above can be embodied as a program and can be stored in a computer readable recording medium. The computer readable recording medium can be of any type of computer readable data storage device. It includes a read-only memory (ROM), a random-access memory (RAM), a CD-ROM, a floppy disk, a hard disk and an optical magnetic disk.

As described above, the mobile terminal according to an embodiment interrupts the data path for blocking the data flow from the external device to the mobile terminal when the mobile terminal and the external device are not in communication with each other. Therefore, the mobile terminal prevents power-on errors caused by the inverted data from the transceiver, such as faulty turn-on/off and faulty activation of the mobile terminal. The embodiment may prevent a faulty activation of a liquid crystal display of a mobile terminal.

The foregoing description is that of embodiments of the invention and various changes, modifications, combinations and sub-combinations may be made without departing from the spirit and scope of the invention, as defined by the appended claims.

What is claimed is:

1. A wireless communication device, comprising:
a power input configured to receive electrical power from an external device;
a data input configured to receive a data signal from the external device;
a processor configured to process the data signal; and
a circuit interconnecting the data input and the processor, the circuit configured to electrically connect the data input to the processor only when electrical power at the power input is greater than a predetermined level.

2. The device of claim 1, wherein the wireless communication device comprises a mobile phone, a personal digital assistant (PDA), or a hand-held computer.

3. The device of claim 1, wherein the circuit comprises a first terminal connected to the data input, a second terminal connected to the processor, and a switch configured to connect or disconnect the first and second terminals based on the level of the electrical power at the power input.

4. The device of claim 3, wherein the switch comprises a transistor comprising a source connected to the first terminal, a drain connected to the second terminal and a gate connected to the power input.

5. The device of claim 1, wherein the circuit is configured to electrically disconnect the processor from the data input when the electrical power at the power input is less than the predetermined level.

6. The device of claim 1, wherein the predetermined level is a level of electrical power sufficient to operate the processor.

7. The device of claim 1, wherein the predetermined level is represented by an electrical potential.

8. A wireless communication device, comprising:
a power input configured to receive electrical power from an external device;
a data input configured to receive a data signal from the external device;
a processor configured to process the data signal; and
a circuit interconnecting the data input and the processor, the circuit configured to electrically disconnect the data input from the processor when electrical power at the power input is less than a predetermined level.

9. The device of claim 8, wherein the wireless communication device comprises a mobile phone, a personal digital assistant (PDA), or a hand-held computer.

10. The device of claim 8, wherein the circuit comprises a first terminal connected to the data input, a second terminal connected to the processor, and a switch configured to connect or disconnect the first and second terminals based on the level of the electrical power at the power input.

11. The device of claim 10, wherein the switch comprises a transistor comprising a source connected to the first terminal, a drain connected to the second terminal and a gate connected to the power input.

12. The device of claim 8, wherein the circuit is configured to electrically connect the data input and the processor when the electrical power at the power input is greater than or equal to the predetermined level.

13. The device of claim 8, wherein the predetermined level is a level of electrical power sufficient to operate the processor.

14. A method of supplying data to a processor of a wireless communication device, the method comprising:
providing a wireless communication device comprising a processor, a power input, and a data input;
providing an external device comprising a power supply port and a data supply port;
electrically connecting the power input to the power supply port and the data input to the data supply port; and
electrically connecting the data input to the processor only when electric power at the power input is greater than or equal to a predetermined level.

15. The method of claim 14, wherein the data input and the processor are not electrically connected when the electric power at the power input is less than the predetermined level.

16. The method of claim 14, wherein the external device comprises software for testing operation of the wireless communication device.

17. The method of claim 14, wherein the external device is configured to supply electrical power to the wireless communication device through the power supply port, and wherein the external device is configured to supply data for testing the wireless communication device through the data supply port.

18. The method of claim 14, wherein the external device has a first level of electric power for operating the external device, wherein the first level is different from the predetermined level, and wherein the external device comprises a circuit for converting the first level to the predetermined level.

19. The method of claim 14, wherein the data supply port occasionally supplies an unintended signal to the data input while the power supply does not supply electrical power to the power input at a level lower than the predetermined level.

20. The method of claim 14, wherein the method is carried out in the course of testing the wireless communication device.

21. The method of claim 14, wherein electrically connecting the data input to the processor is carried out by a circuit interconnecting the data input and the processor, wherein the circuit comprises a first terminal connected to the data input, a second terminal connected to the processor, and a switch configured to connect or disconnect the first and second terminals based on the level of the electrical power at the power input.

22. The method of claim 14, wherein the predetermined level is a minimum level of electrical power sufficient to operate the processor.

23. The method of claim 14, wherein the predetermined level is represented by an electrical potential.
